(19) United States
(12) Patent Application Publication
(10) Pub. No.: US 2011/0078736 A1
(43) Pub. Date: Mar. 31, 2011

(54) SYSTEMS AND METHODS FOR PROVIDING AN OPEN AND COLLABORATIVE MEDIA GUIDANCE APPLICATION

(75) Inventor: William L. Thomas, Malvern, PA (US)

(73) Assignee: Rovi Technologies Corporation, Santa Clara, CA (US)

(21) Appl. No.: 12/571,394

(22) Filed: Sep. 30, 2009

(51) Int. Cl. H04N 5/445

(52) U.S. Cl. 725/40

(57) ABSTRACT

Systems and methods for an open and collaborative media guidance application are provided. Users may join a distribution list to receive and/or provide modifications to media asset description information. A user may provide a modification to the media asset description information provided that he/she has sufficient authorization. The modification may be transmitted to a central server. The central server may filter the modification for improper information. The central server may update the media asset description information based on the received modification. The central server may transmit the modification or the updated media asset description information to media equipment devices associated with a distribution list. The media equipment devices may receive the modifications and process the modification based on local settings to update the locally stored media asset description information.

### BACKGROUND

This application relates to interactive media guidance applications and more particularly to systems and methods for providing an open and collaborative media guidance application.

Traditional systems include a television distribution facility which provides media asset information and media asset schedule information to users in an interactive program guide. These systems typically have an operator input the information for the media assets provided by various services (e.g., on-demand sources and broadcast sources) into a database. The information in the database is then broadcast to a plurality of users.

The communication of information in the database about the various media assets is typically one way. In particular, these systems allow the information stored in the database to be updated by the system operator and not by any of the users. Additionally, because the information is updated by the system operator, inaccuracies and updates may depend on the system operator to be corrected and thus end users may be exposed to outdated or inaccurate information in the interactive program guides.

### SUMMARY OF THE INVENTION

In view of the foregoing, it would be desirable to provide systems and methods for providing an open and collaborative media guidance application. In particular, end users or users of various media equipment devices may be part of a distribution list, and the membership of the distribution list may allow each of the users in the distribution list to receive modifications and updates to media asset description information in a media guidance application. The modifications and updates are provided by users in a contributors list. Some users may belong to (or be a member of) a contributors list while some users belong to a distribution list. The membership in both lists may be the same, partially the same, or completely different. The system may have a plurality of contributors lists for different kinds of contributors. Similarly, the system may have a plurality of distribution lists for users with different needs and choices for modifications and updates of media asset description information.

In some embodiments, a user associated with a first media equipment device may submit a modification to a media asset description information. The user may belong to a contributors list. The modification to the media asset description information may subsequently be distributed to other media equipment devices in a distribution list either directly from the first media equipment device or via a central server.

In some embodiments, to join the distribution list of media equipment devices, a user may opt-in to a distribution list. Likewise, if a user does not wish to receive updates from other media equipment devices of the distribution list, a user may opt-out of a distribution list. A user may selectively opt-in to receive updates based on criteria such as users, fields of the media asset description information, kinds of media assets, etc. A user that is part of a contributors list may receive updates by default without opting in to a distribution list.

In some embodiments, a user may opt-in to receive updates or modifications from media equipment devices of the distribution list of which that he/she is a member. A user may also opt-in to receive updates from members with a certain authorization (e.g., a member with high authorization to make critical changes to the media asset description information, or a group of members that belong to a particular contributors list). In another embodiment, a user may opt-in to receive updates for certain fields of media asset description information, such as title of a media asset. Fields of media asset description information may include program metadata, program description data, title, cast members, director information, reviews, commentary from media equipment devices in a distribution list and program summary. In yet another embodiment, a user may opt-in to receive updates for certain kinds of media assets.

In some embodiments, a user may automatically receive updates (or automatically/voluntarily become part of a distribution list) based on his/her need to receive modifications and updates. For instance, a user who has scheduled recordings may automatically receive updates from other members regarding schedule changes, without being a member of a distribution list (or specifying that he/she would like to receive schedule updates and modifications). The modifications and updates may originate from a contributors list that includes members authorized to make schedule changes. The user who had scheduled a recording may or may not belong to a distribution list.

For example, a first user has scheduled an episode of Family Guy for recording. The selection to record Family Guy may be stored in a centralized server (e.g., processing server 508). Alternatively, the selection to record may be stored on the local user equipment device of the first user. A second user, a member of a contributors list, updates the broadcast time of the Family Guy episode, and the update is transmitted to a selected number of distribution lists and to the central server. Upon determining that the user had scheduled a recording of that Family Guy episode, the centralized server may transmit the update made by the second user to the first user, even though the first user may not be part of a distribution list (such as a distribution list selected by the second user). Accordingly, users who are not a member of any lists nevertheless records the selected Family Guy episode at the time updated by someone belonging to a contributors list.

In some embodiments, different fields of media asset description information may have different sensitivities. In some implementations, certain fields of the media asset description information may benefit having more media equipment devices provide modifications (e.g., less sensitive), and certain fields may benefit having a limited number of media equipment devices provide modifications (e.g., more sensitive). In some implementations, title field of the media asset description information may be less sensitive than the media asset summary field of the media asset description information. In some embodiments, users are given an authorization level to control which fields a user with a given authorization level can modify. In certain embodiments, users with different authorization levels may belong to different contributors lists. Some users who have a higher authorization level may be allowed to edit more fields than users who have a lower authorization level. Modifications made by a user of a media equipment devices may be stored in a modification data structure. The modification data structure may be transmitted to the central server and/or to other media equipment devices in a distribution list.

After a modification of the media asset description information is received, the modification may be checked to determine whether the modification was proper or improper. In one embodiment, the check can determine whether the modification has originated from an authorized user with the sufficient authorization to make the update indicated in the modification. In some embodiments, the check can determine whether offensive language was used, and to auto-correct/reject modifications that are deemed improper or inappropriate. In some embodiments, the check can determine whether there are other errors in the modification, such as typographical errors. If the modification has been deemed proper, the media description information stored in the memory, of for example a central server, may be updated.

In some embodiments, the updated or modified media asset description information may be transmitted from the central server to all the media equipment devices in the distribution list. In some implementations, the updates or modifications to the media asset description information may be transmitted in a modification data structure. In some embodiments, the media equipment devices in the contributors list may transmit modifications made to the media asset description information directly to each other in a peer-to-peer configuration. A media equipment device may receive the modification data structure and update a locally stored media asset description information based on the information in the modification data structure. In some implementations, a media equipment device may apply local rules to process the modification data structure such that only a subset of the modified media asset description information fields that were modified are updated on the media equipment device.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIGS. 5 and 6 show illustrative display screens of a media guidance application navigation screen that allows a user to add a media equipment device to a distribution list in accordance with an embodiment of the invention;

FIG. 7 shows an illustrative display screen of media asset description information modification in accordance with an embodiment of the invention;

FIG. 8 shows an illustrative display screen of a modification to a field of media asset description information in accordance with an embodiment of the invention;

FIG. 9 shows an illustrative display screen of media asset description information modification confirmation in accordance with an embodiment of the invention;

FIG. 10 shows an illustrative display screen of media asset schedule information modification in accordance with an embodiment of the invention;

FIG. 11 shows an illustrative display screen of media asset description information modification for user with a high authorization level in accordance with an embodiment of the invention;

FIG. 12 shows an exemplary modification data structure in accordance with an embodiment of the invention; and

FIGS. 13 and 14 are illustrative flow diagrams for providing an open and collaborative media guidance application in accordance with an embodiment of the invention.

### DETAILED DESCRIPTION OF EMBODIMENTS

The amount of media available to users in any given media delivery system may be substantial. Consequently, many users desire a form of media guidance through an interface that allows users to efficiently navigate through media selections and easily identify media content that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), recorded programs, and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but may also be part of a live performance. It should be understood that the invention embodiments that are described in relation to media or media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

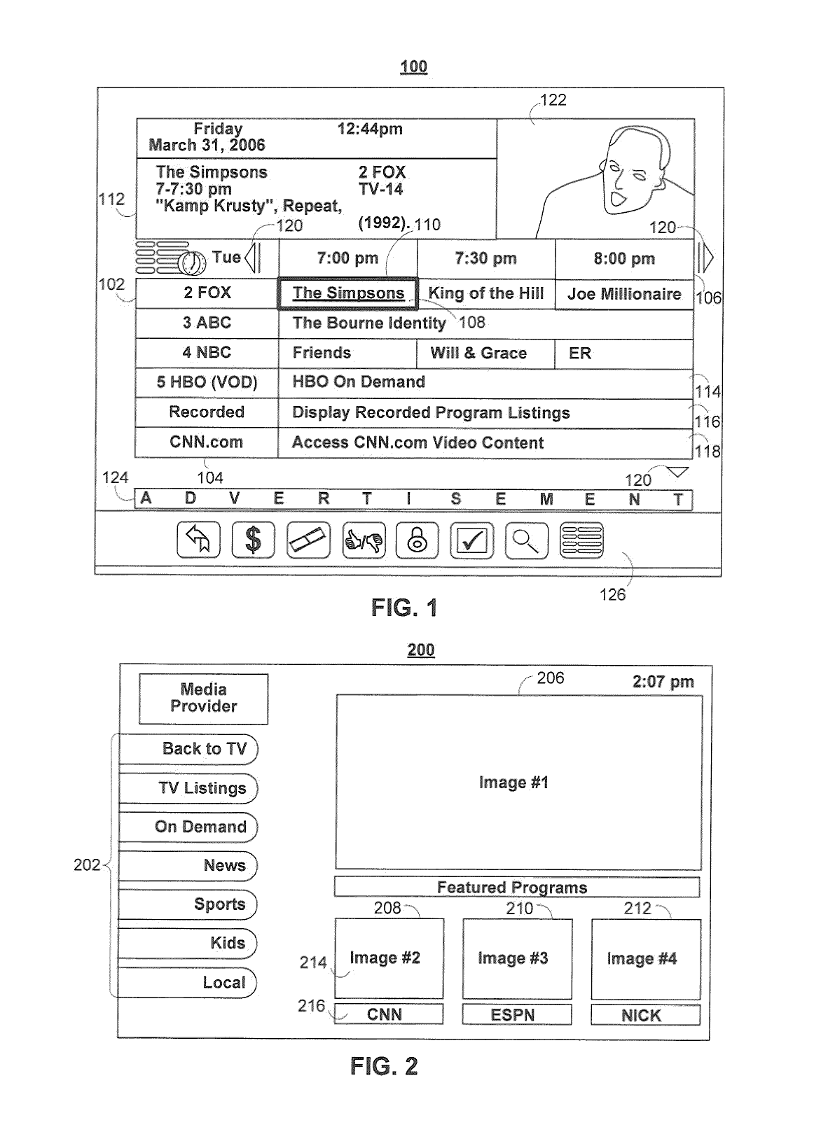

One of the functions of the media guidance application is to provide media listings and media information to users. FIGS. 1 and 2 show illustrative display screens that may be used to provide media guidance, and in particular media listings. The display screens shown in FIGS. 1-2 and 5-11 may be implemented on any suitable device or platform. As defined herein, platform refers to any system that may support the operation of an interactive media guidance application. While the displays of FIGS. 1-2 and 5-11 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user may select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120).

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display screen or embedded within a display screen. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

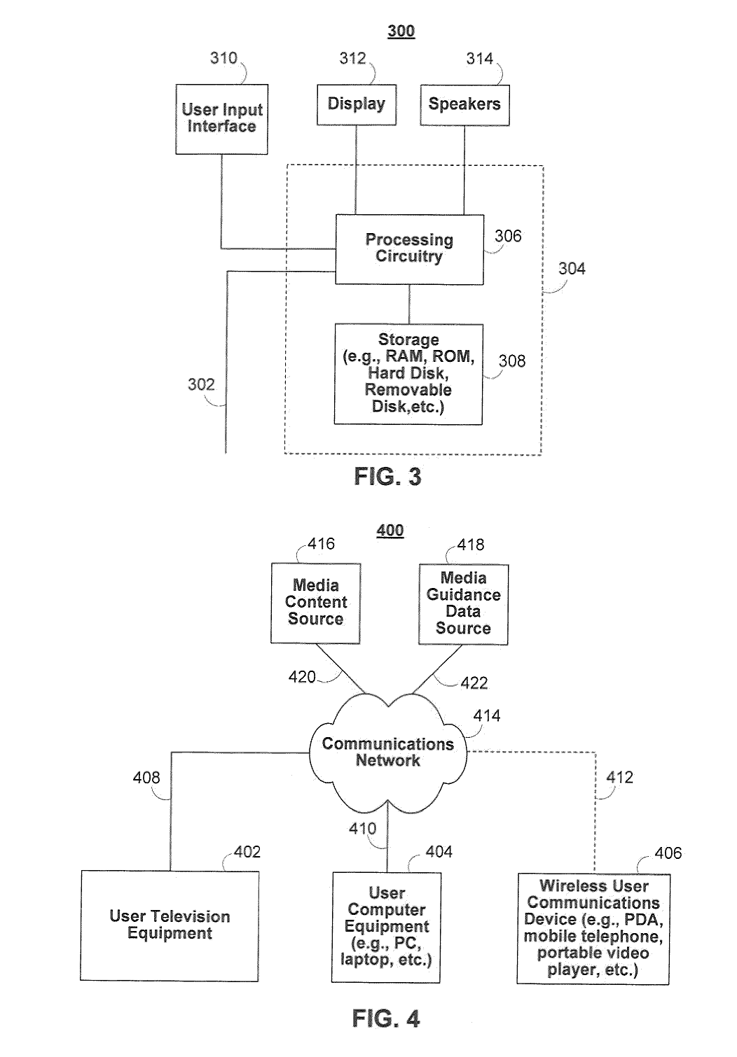

Media guidance application features that may be available through options region 126, or any other suitable selectable options in any other suitable display (e.g., display 200 of FIG. 2), may include, for example, music and interactive game applications. Music applications may be located remotely as on-line music applications or may be stored locally on the user's media guidance equipment (e.g., storage 308 of FIG. 3). Music applications may allow a user to, for example, download music, listen to and/or preview music, organize music libraries, and search for music related to other media guidance information (e.g., music related to program listings in grid 102 of FIG. 1). Interactive game applications may allow a user to, for example, download and play interactive games within the media guidance application. The interactive games may be related to or independent from other media located within the media guidance application. There may be any number of other interactive applications that are accessible via an interactive media guidance application, and these applications may contain content that is complimentary to, or distinct from content provided by the interactive media guidance application.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile, which may be customized for each user who interacts with the media guidance application. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the media guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user may be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, listings 206, 208, 210, and 212 may be provided, for example, as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, advertisements, or other types of media that indicate to a user the media content being described by the listing. Each of the graphical listings may also be accompanied by text to provide further information about the media content associated with the listing. For example, listing 208 may include more than one region, including media region 214 and text region 216. Media region 214 and/or text region 216 may be selectable to view video in full-screen or to view program listings related to the video displayed in media region 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

In some embodiments, media asset description information may be stored in a memory (e.g., a database) of a central server. For example, the central server may include media asset data source that provides media asset information to media equipment devices in a network and media asset content source. In particular, media asset data source may be the same or similar as media guidance data source 418 (FIG. 4).

In some embodiments, the central server may be a television distribution facility or media guidance application distribution facility. The media asset description information may include a description of content of one or more media assets provided by the media content source 416; summaries of one or more media assets provided by the media content source 416; titles of one or more media assets provided by the media content source 416; cast member information of one or more media assets provided by the media content source 416; and director information of one or more media assets provided by the media content source 416. Any other description information associated with a particular media asset may also be included. In some implementations, the media asset description information may include schedule, broadcast or source information of a particular media asset.

The central server may provide the stored media asset description information to a plurality of media equipment devices in the network. Each of the plurality of media equipment devices may display the media asset description information and use the information to access various corresponding media assets. In some embodiments, a media equipment device (or a user) may belong to a distribution list which includes a plurality of media equipment devices, and another media equipment device (or another user) may belong to a contributors list which includes a plurality of media equipment devices as well. Any one of the media equipment devices in the distribution list may receive user modifications to the media asset description information that originated from devices or users in the contributors list. For example, processing circuitry 306 of a first media equipment device may receive a user modification to a media asset summary field of a particular media asset corresponding to the media asset description information. More specifically, a user in the contributors list may add or change typographical errors or description to the media asset summary.

Processing circuitry 306 may transmit the modifications of the media asset description field to the central server. After the central server authenticates and filters the modifications, the central server may update the media asset description field based on the modifications. The central server may transmit the updated media asset description field to all the media equipment devices that belong to the distribution list associated with the first media equipment device.

In some embodiments, a user of a media equipment device may select an option within the media guidance application to add the media equipment device to a distribution list. The media equipment device may navigate the user to a screen that allows the user to configure the settings and select a particular distribution list to which to be added. In particular, the user may configure and instruct the media equipment device on how to handle various modifications that are received for the media asset description information. For instance, the user may instruct the device to only accept modifications that had originated from a particular contributors list.

The media equipment device may be added to a contributors list that is associated with a plurality of media equipment devices. Each media equipment device in the contributors list may transmit modifications to media asset description information to a central server. The central server may update the media asset description information based on the modifications and provide the updated information to the media equipment devices in the distribution list.

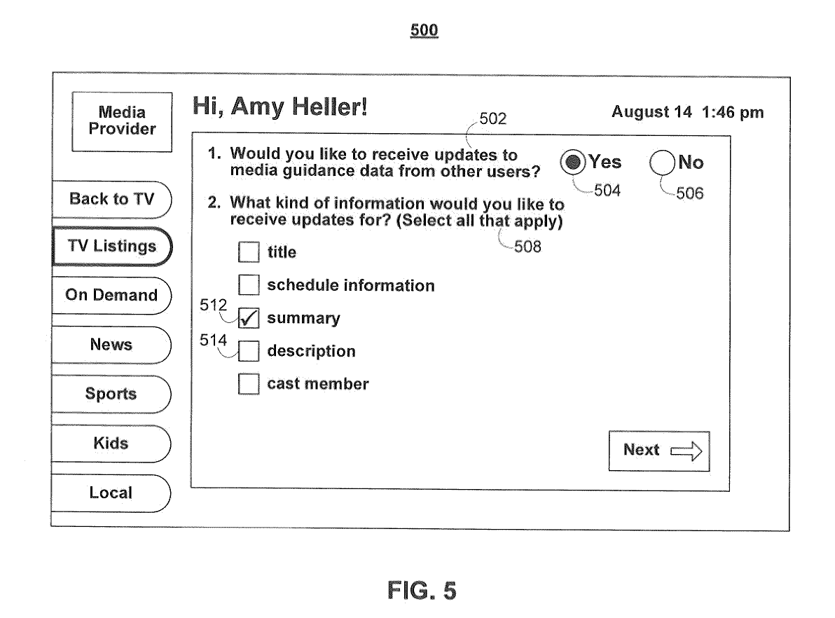

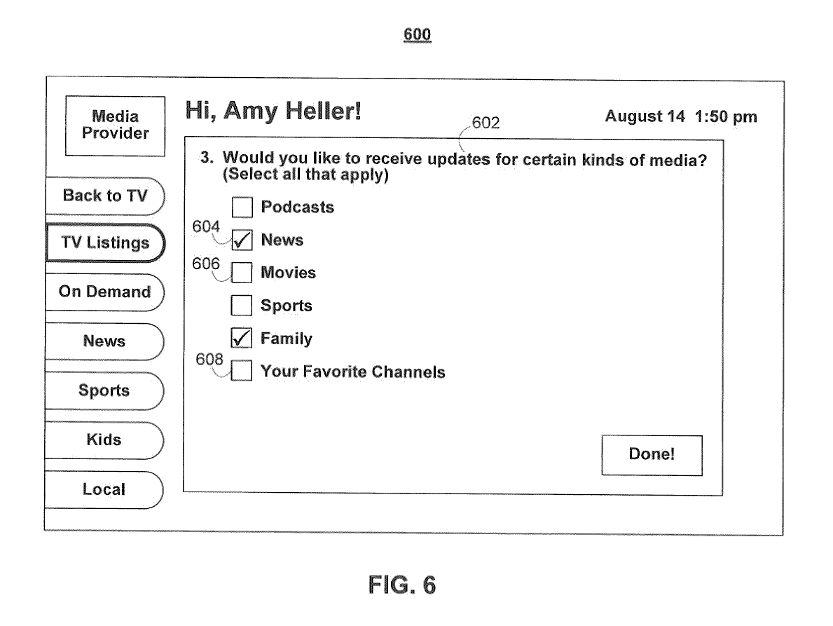

FIGS. 5 and 6 show illustrative display screens 500 and 600 of a media guidance application navigation screen that allows a user to add a media equipment device to a distribution list in accordance with an embodiment of the invention. Screen 500 may include a window of options that allow the user to configure the media equipment device to be added and receive modifications associated with a particular distribution list. The window may include an enabling option 502 which queries the user as to whether the user would like to receive updates to the media asset description information from other users. Enabling option 502 may include a YES radio button 504 and a NO radio button 506.

A user may become a member of a distribution list by need or by choice. As described in relation to FIGS. 5 and 6, a user may choose to be a member of a distribution list based on the selections made in screens 500 and 600. In some embodiments, a user may become a member of a distribution list by need. For instance, if a user has scheduled recordings, the user may, by default, be a member of a distribution list. The distribution list include users who wishes and/or needs to receive updates for schedule information. In certain embodiments, system administrators are part of a contributors list. All or most users of the system may be part of a distribution list that receive updates from the system administrators contributors list.

Processing circuitry 306 of the media equipment device may receive a user selection of YES radio button 504. As a result, processing circuitry 306 may configure the media equipment device to communicate with the central server to receive updates to the media asset description information. Processing circuitry 306 of the media equipment device may receive a user selection of NO radio button 506. As a result, processing circuitry 306 may configure the media equipment device to ignore communications from the central server which indicate updates to the media asset description information.

Processing circuitry 306 may configure the types of modifications the media equipment device receives and processes based on the modification type information region 508. In particular, the media equipment device may be enabled to receive and process modifications of the media asset description information only for certain fields of the media asset description information. More specifically, even though a media equipment device may be part of a distribution list, the media equipment device may be configured to only accept modifications made to certain fields of the media asset description information. The fields of the media asset description information that may be selected for inclusion in the modification and processing may include a title field, schedule information, summary field, program description field, cast member field and director field, or any other suitable program description information fields. For example, processing circuitry 306 may receive a user selection of a summary field 512 which enables the media equipment device to receive and make modifications of the summary field of the media asset description information.

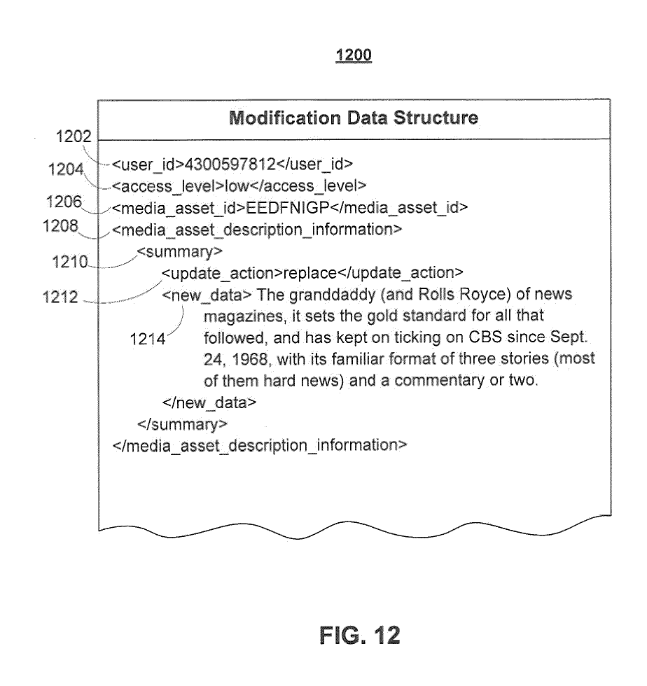

For example, the media equipment device may be part of a certain distribution list. A first of the media equipment devices in the distribution list may receive a modification to the summary field and the cast member field of the media asset description information. The modifications may be transmitted to the central server in a modification data structure 1200 (FIG. 12). The central server may update the summary field and the cast member field of the media asset description information and promulgate the changes to the media equipment devices in the distribution list. When the summary field 512 is selected for inclusion in the modifications, processing circuitry 306 of a second media equipment device may receive the changes and updates to the media asset data structure and process the updates to the summary field made by the first media equipment device. Processing circuitry 306 of the second media equipment device may ignore or prevent updates made to the cast member field by the first media equipment device since that field was not selected in screen 500.

Processing circuitry 306 may receive a user selection of a next option and as a result may display additional preferences in screen 600. The additional preferences may include a region 602 that allows the user to select one or more distribution lists 604, 606 and 608 to which to be added. For example, the distribution lists may include content based distribution lists, location based distribution lists, people based distribution lists, channel based distribution lists, or any other suitable type of distribution list.

Contributors lists may be organized based upon similar factors upon which distribution lists are based. For instance, members of a certain contributors list may be able to edit only certain fields of the media asset description information. Members of another contributors list may be able to edit the media asset description information of only certain genre(s) of media assets. Members of another contributors list may include at least one of: general users, editors, programmers, broadcasters/networks, and content owners.

In some embodiments, the user may select to be a part of a news based contributors list 604. Processing circuitry 306 may add the user to a contributors list that is associated with media equipment devices that are configured to make modifications to news media assets. For example, media equipment devices and/or users may register themselves with the central server as being configured to make modifications to news type media assets. Processing circuitry 306 may add the media equipment device to the news based distribution list using a similar mechanism as selecting option 604. In certain embodiments, the user may be automatically added to the distribution list for receiving modifications and updates associated with news type media assets.

Members of a contributor's list may have the ability to select one or more distribution lists to which to send modifications and updates. For instance, content providers may choose all distributions lists to distribute modifications and updates. In some embodiments, a member of a contributors list (e.g., a member of a content provider contributors list) may choose to distribute modifications and updates to all users, even if the users do not belong to a distribution list. In some embodiments, a member of a contributors list may be able to create distribution lists for the contributors list, or for the member himself/herself. The member may be able to select at least one distribution list (or contributors list) to distribute modifications and updates. For instance, a member of a contributors list may select to distribute modifications and updates to only the members a news type distribution list.

In some embodiments, the user may select a family based contributors list. Processing circuitry 306 may join the media equipment device to a group of media equipment devices associated with different members of a particular family. For example, the family may be in a single home network and processing circuitry 306 may add the media equipment device to the household of media equipment devices. As a result, when any media equipment device in the household receives a modification to the media asset description information from a given user, those modifications may be provided to the other media equipment devices in the household (either directly or via the central server). In this embodiment, the distribution list and contributors list each includes all family members of the household.

In some embodiments, a user may join a distribution list of users with certain authorization levels. For example, a user may include a media equipment device in a distribution list that is associated with media equipment devices with users having high authorization levels (e.g., members of a high authorization contributors list). This may give the user confidence that any modifications received from the media equipment devices in the distribution list will be valuable or from trustworthy sources (as discussed above and below). In some implementations, only users with a particular authorization level (e.g., high authorization level) may be allowed to join a distribution list associated with media equipment devices having high authorization levels. In some implementations, a user may configure the media equipment device to opt-in to receive and process modifications only made by users with low authorization levels. In such circumstances, when low authorization level users (e.g., members of a low authorization contributors list) are only permitted to supplement (and not delete or change) the media asset description information, the media equipment device may receive and process commentary or reviews provided by media equipment devices in the distribution list.

In some embodiments, the user may configure the media equipment device to process received modifications based on the authorization level of the user that made the modification. For example, the media equipment device may process modifications received from a user with high authorization level that make changes to schedule information field of media asset description field and ignore such modifications received from a user with medium media authorization level even though both the high authorization level user and the medium authorization level may be associated with media equipment devices in the same contributors list.

The user may also be provided with an option (not shown) to have processing circuitry 306 of the media equipment device exclude modifications made by one or more particular media equipment devices in a contributors list. For example, the user may specify a particular media equipment device in the family or group of media equipment devices from which not to processes modifications made to the media asset description information. More specifically, a household may include a media equipment device associated with parents and another media equipment device associated with the child where each is in the same contributors list. The media equipment device associated with the parents may be configured to ignore modifications made to the media asset description information by the child while the media equipment device associated with the child may be configured to accept and process modifications made by the media equipment device associated with the parents.

In some embodiments, the media equipment devices in a given distribution list and/or contributors list may communicate through peer-to-peer connection. In particular, in such scenarios, a modification made by one media equipment device in the contributors list may be transmitted with a modification data structure 1200 (FIG. 12) directly to all of the media equipment devices in the given distribution list without first being transmitted for approval by the central server. Such scenarios may require each media equipment device in the contributors list to monitor and filter the modifications for improper content. In such scenarios, the central server may or may not be informed of the modifications made to the media asset description information by any of the media equipment devices.

In some embodiments, instead of sending the modifications to each of the media equipment devices in the distribution list, the modifications may be stored in a central location (e.g., in the central server). When a media equipment device in a given distribution list, accesses media asset description information, the media equipment device may query the central location to determine whether a modification has been made to the media asset description information. When a modification has been made by, for example, another media equipment device in the contributors list, the modification data structure 1200 may then be transmitted to the requesting media equipment device which may subsequently process the modification to display the updated media asset description information.

The options and preferences shown and described in screens 500 and 600 may be included in one display screen or multiple display screens. For the sake of clarity, the options of configuring the distribution list are presented in two separate screens 500 and 600. The user may select a done option in screen 600 to store the options and preferences associated with the distributions lists selected for configuring the media equipment device to receive modifications to the media asset description information.

In some embodiments, a media equipment device may receive media asset description information from a central server. The media equipment device may display the media asset description information with options to make modifications to the displayed media asset description information. The media equipment device (e.g., a device belonging to a distribution list) may receive modifications to the media asset description information and generate a modification data structure for transmission to the central server. A user may be provided with the option to rate (e.g., a 5-star system) to rate the quality of the media asset description information (rating system is not shown). In some embodiments, a user may be provided with the option to report abuse, when he/she sees that the media asset information has been improperly modified.

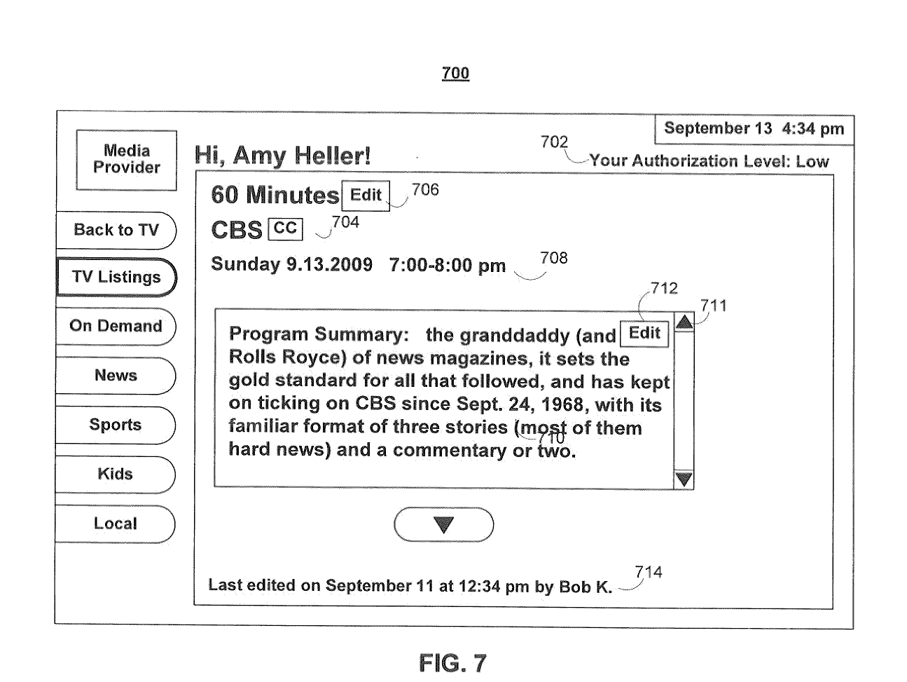

FIG. 7 shows an illustrative display screen 700 of media asset description information modification in accordance with an embodiment of the invention. Screen 700 may include a window in which information associated with a particular media asset is provided. For example, the user may browse program listings in the media guidance application (e.g., from a grid guide of program listings screen or while viewing a media asset in an overlay). The user may select a media asset (e.g., 60 Minutes) from the program listings and be provided with an option to receive detailed information about the selected media asset. Processing circuitry 306 may receive a user selection of the option to receive detailed information and generate screen 700 as a result.

Processing circuitry 306 may retrieve from memory information associated with the selected media asset and generate screen 700 with the retrieved information. Among the retrieved information, processing circuitry 306 may retrieve media asset description information fields (e.g., title, summary, description, cast members, directors, etc.).

Processing circuitry 306 may display information identifying when and which media equipment device of the contributors list made a modification to the media asset description information. For example, processing circuitry 306 may display in region 714 information indicating when the last modification to the media asset description information was made. Processing circuitry 306 may also identify the user and/or the media equipment from which the modification was made. In some embodiments, the user may select region 714 to receive a detailed report (e.g., a redline) (not shown) depicting the modifications made to the media asset description information by each user in the contributors list.

Processing circuitry 306 may determine whether the media equipment device is enabled for making and receiving modifications to the media asset description information (e.g., “does this user belong to a high authorization contributors list?”). When the media equipment device or user has provided modifications, processing circuitry 306 may determine the authorization level of the user associated with the media equipment device. The authorization level may indicate which of the fields of the media asset description information the user may modify. The authorization level may also indicate how much text or data the user may provide for a given field of the media asset description information and how often the user may make such modifications.

Processing circuitry 306 may display in screen 700 the authorization level 702 associated with the user. Processing circuitry 306 may provide edit options 706 and 711 for different fields in the media asset description information based on the authorization level associated with the user. For example, the user may be assigned a low authorization level and accordingly, the user may only make modifications to the title field 704 and the program summary field 710 of the media asset description information. In some implementations, a user with low authorization level may not be provided with an option to edit schedule information 708.

In some implementations, a user with a low authorization level may only add text or content to certain fields of the media asset description information but may not change or delete any content. For example, a user with a low authorization level may add commentary (e.g., a review, likes, dislikes, and recommendations) about the media asset associated with the media asset description information (e.g., in a program description field) but may be prevented or may not be allowed to change the information or content in the media asset description information fields. Such a feature allows various users of media equipment devices in the contributors list to provide commentary and feedback to each other about the media asset without affecting the content of the media asset description information.

In some embodiments, the user may be provided with a higher authorization level based on the user's level of trustworthiness as set by, for example, the central server. For example, the trustworthiness may be set to be higher for a user that has contributed to the system for a relatively long period of time. The longer the user has been contributing (e.g., measured by time, or number of modifications that the contributor user has submitted in the past) the more trustworthy the user may be. In some implementations, the trustworthiness of the user may be increased in accordance with ratings of the user where the more highly rated (e.g., measured by ratings submitted by other users) the user, the higher the trustworthiness of the user. In some implementations, the trustworthiness of the user may be increased in accordance with the number and quality of the modifications made by the user. For example, other users in the contributors list (and/or other users in a distribution list) may comment or indicate a level of interest in a particular user's modifications. When central server receives a number (e.g., more than 100) of indications from a variety of members in the distribution lists that specify an interest in a particular user's modifications, central server may increase the authorization level and trustworthiness of the user in which the other members have an interest.

Processing circuitry 306 may include in program summary field 710 a brief description of the media asset content corresponding to the selected media asset. A scroll bar 711 may be provided to allow the user to scroll the brief description up/down to view more information. Edit option 712 may be provided to allow the user in a contributors list to make modifications to media asset summary field 710. Similarly, edit option 706 may be provided to allow the user to make modifications to media asset title field 706. For example, processing circuitry 306 may receive a user selection of edit option 712. As a result, processing circuitry 306 may navigate the user to a screen that allows the user to make modifications to the program summary content that is displayed.

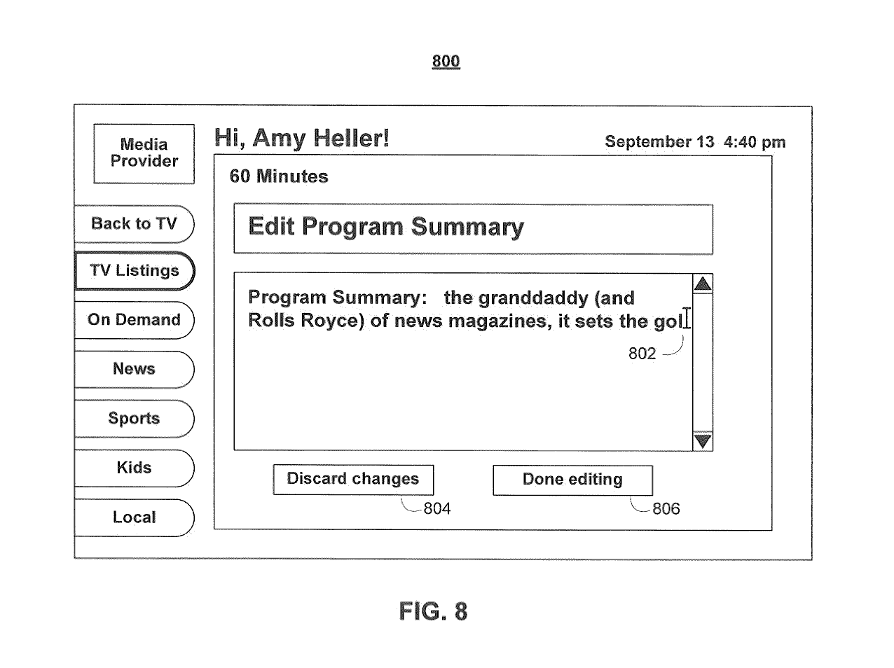

FIG. 8 shows an illustrative display screen 800 of a modification to a field of media asset description information in accordance with an embodiment of the invention. Screen 800 may include an interactive program summary window 802, discard changes option 804 and done editing option 806. Interactive program summary window 802 may initially include the content shown in summary field 710 (FIG. 7). The user may make modifications (e.g., add, delete or change) words included in the program summary. For example, as shown in window 802, the user has removed words from the summary field 710 to make the summary more concise. The user may also add various information such as hyperlinks or other data that other users may find useful to know when reading the program summary of the media asset.

Processing circuitry 306 may receive a user selection of discard changes option 804. As a result, processing circuitry 306 may ignore all the modifications made in window 802 and may navigate the user back to screen 700 (FIG. 7) with the previous content displayed in summary field 710. In some implementations, processing circuitry 306 may return the user to the previously accessed or view media asset upon receiving a user selection of discard changes option 804.

After the user has made the modifications to the program summary field of the media asset description information, the user may select done editing option 806. As a result, processing circuitry 306 may store the modifications to the media equipment device and generate a modification data structure 1200. Modifications data structure 1200 (FIG. 12) may include various fields that identify the user field 1202, the authorization level of the user field 1204 and the media asset field 1206 to which the modification applies.

Modification data structure 1200 may include a media asset description information field 1208 which identifies the changes made to the media asset description information. For example, the user in screen 800 replaced content of summary field 710 (FIG. 7) and accordingly a summary field 1210 may be included in which the type of modification that is requested is provided in action field 1212 along with the corresponding data in data field 1214. More specifically, the modification requested or made by the user may be a replacement of the content in the summary field of the media asset description information with new data.

Modification data structure 1200 may be stored in memory and subsequently transmitted to the central server (or in some embodiments directly to other media equipment devices in the distribution list directly). In some embodiments, modification data structure 1200 may be transmitted on a periodic basis, when polled by the central server or when the user instructs processing circuitry 306 to transmit the modification data structure 1200. For example, processing circuitry 306 may cause the media equipment device to transmit over the Internet or some other network the modification data structure to the central server or other media equipment devices.

The central server may receive modification data structure 1200 from the media equipment device. The central server may parse the various fields of the modification data structure to determine the authorization level of the user and the modifications requested to be made to a particular media asset description information. The central server may determine based on the authorization level of the user whether the proposed or requested modifications exceed the authorization privileges of the user. The central server may ignore or prevent any modifications proposed to be made to the media asset description information that are outside of the authorization level associated with the user.

The central server may also parse through and filter words or phrases which are improper in the requested modification. For example, modification data structure 1200 may include curse words or other improper language or content that is incorrect which central server may automatically filter out. In particular, the central server may remove improper language or correct the improper language. In some embodiments, when the central server detects improper language in modification data structure 1200, the central server may downgrade an authorization level associated with the user, provide an error message for the user, or prevent the user from making any future modifications and remove the user from the contributors list. In some circumstances, the central server may provide a warning to the user indicating that if improper language is detected in any future requests, the user will be removed from the contributors list and prevented from making subsequent modifications. In some embodiments, an operator at the central server or other users may monitor each requested modification for improper language instead of using the automatic filtration system. In some embodiments, the automatic filtration may be combined with the user monitoring to control the content provided through the requested modifications.

After a requested modifications is approved by the central server, the central server may store or update the memory in which the original media asset description information is stored with the content of the requested modification in modification data structure 1200. The central server may retrieve a distribution list that is associated with media equipment devices that have an interest in receiving the modification. For example, the central server may retrieve a distribution list in which the media equipment devices indicated an interest in receiving program summary modifications. The central server may transmit data structures or instructions to each of the media equipment devices in the retrieved distribution list(s) that include the modifications made by the media equipment device to, for example, the program summary field of the media asset description information.

A media equipment device may receive the modification from the central server or directly from one of the media equipment devices in the contributors list. As a result, the media equipment device may automatically update the stored media asset description information based on the modification that is received from the central server. For example, the media equipment device in a distribution list may replace the content or data in the program summary field of the media asset specified in the modification with the content or data included in the modification (where the modification was produced by a media equipment device in a contributors list).

In some implementations, the media equipment device may exclude modifications specified by the central server when the user requested to opt-out of those modifications. For example, the user may specify in screen 500 (FIG. 5) which modifications to exclude from being updated by checking various options in region 508 and 602 (FIG. 6). Similarly, the media equipment device may update the stored information based on modifications specified by the central server when the user requested to opt-in to those modifications. For example, the user may specify in screen 500 (FIG. 5) which modifications to update by checking various options in region 508 and 602 (FIG. 6).

In some implementations, the media equipment device that receives the modifications from the central server may prompt the user about each of the specified modification. The media equipment device may only update the stored media asset description information when the user confirms the change to be made. For example, the media equipment device may display a prompt (not shown) for the user indicating that a user of a media equipment device in the contributors list has made a modification to a field of a media asset description information. The user may select an option to accept or reject the modification. In some implementations, the prompt may include the details of the modification and allow the user to edit the modification. When the user selects an option to edit the modification, an edit screen similar to screen 800 (FIG. 8) may be provided allowing the user to transmit a modification data structure 1200 to central server with a proposed modification to the modification that was transmitted by the central server.

In some embodiments, after the central server has approved the proposed modification, the central server may transmit a message back to the media equipment device from which the modification data structure 1200 was sent. The message may indicate that the modification was approved and/or may indicate what content was removed by the filtration mechanism of the central server.

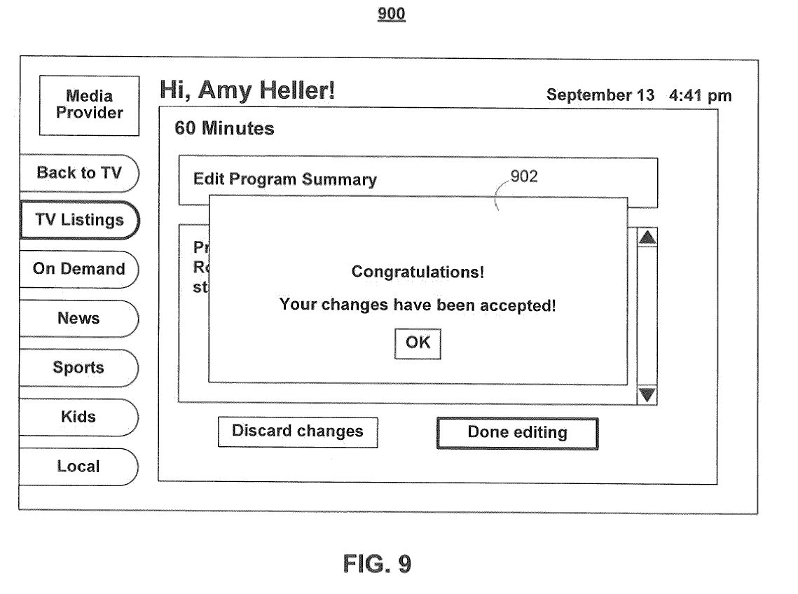

FIG. 9 shows an illustrative display screen 900 of media asset description information modification confirmation in accordance with an embodiment of the invention. Screen 900 may include a prompt 902 indicating that the modifications proposed by the user have been accepted. The user may select an OK option to return to the detailed information screen 700 of the media asset. The detailed information screen 700 may now include the changes or modifications made by the user. In some embodiments, when improper language was detected or filtered by the central server, prompt 902 may alert the user about the improper language and warn the user about the consequences of future provisions of improper language (as discussed above).

In some embodiments, media equipment devices in a contributors list may allow users to modify schedule information associated with a media asset. In some implementations, only users with sufficient authorization levels (e.g., high authorization level) may be provided with the capability to modify schedule information associated with a media asset. After the schedule information is modified by a user and the modification is approved by the central server (when appropriate), the modification may be provided to all the media equipment devices in the distribution list. Any media equipment device in the distribution list that has action settings (e.g., reminders set or recordings scheduled) for the media asset may update the action settings to reflect the schedule change.

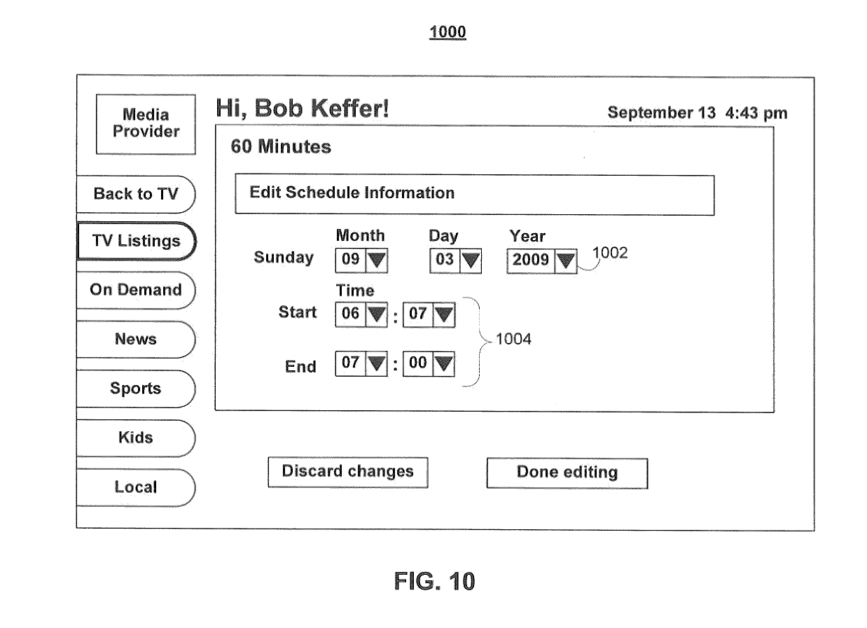

FIG. 10 shows an illustrative display screen 1000 of media asset schedule information modification in accordance with an embodiment of the invention. Screen 500 shows a schedule modification screen that may be navigated to by the user with sufficient authorization level from screen 700 by, for example, selecting an edit option (not shown) displayed next to the schedule information for the 60 Minutes media asset. The schedule modification screen may include a date setting 1002, time settings 1004 and channel settings (not shown).

The user may adjust the date in which the media asset is broadcast or provided by setting a particular date using date setting 1002. For example, date setting 1002 may include drop down menu options that allow the user to select numbers or other representations (e.g., month names) corresponding to the desired modification for the date. Similarly, the user may adjust the time at which the media asset is broadcast or provided by setting a particular time using time setting 1004. For example, time setting 1004 may include drop down menu options that allow the user to select numbers corresponding to the start and end time for the desired modification for the time. In some implementations, the user may adjust the channel or source (e.g., Internet, online video vendor, website) that provides or broadcasts the media asset by setting a source of the media asset using a source setting (not shown).

Processing circuitry 306 may receive a user selection of a discard changes option. As a result, processing circuitry 306 may ignore all the modifications made in screen 1000 and may navigate the user back to screen 700 (FIG. 7) with the previous content displayed in the schedule information field. In some implementations, processing circuitry 306 may return the user to the previously accessed or view media asset upon receiving a user selection of the discard changes option.

In some embodiments, the user (e.g., a member of a contributors list) may modify schedule information for a media asset as the user is accessing the media asset. For example, the user may be viewing a media asset (e.g., a sporting event) which is scheduled to end at a certain time (e.g., 8 PM). When the media asset (e.g., a sporting event) runs over the certain time (e.g., because of overtime in the game), the end time of 8 PM stored in the schedule information may no longer be accurate. Accordingly, the user may modify the schedule information to insert a new end time (e.g., 8:45 PM). The new end time may be transmitted to the central server for approval or transmitted directly to all the media equipment devices in the distribution list. In some embodiments, a second media equipment device in the distribution list may be programmed to schedule a recording of the media asset (e.g., a sporting event). However, since the media asset (e.g., a sporting event) has run over the scheduled end time, the second media equipment device may not record portions of the media asset (e.g., a sporting event) that are provided past 8 PM (e.g., the scheduled end time). As a result of receiving the modification to the schedule information (performed by another media equipment device belonging to a contributors list), the second media equipment device may adjust the recording settings to end or stop recording at 8:45 PM instead of 8 PM.

In some implementations, the second media equipment device may be configured to provide a reminder for a particular media asset. For example, the second media equipment device may be configured to provide a reminder for a sporting event when the sporting event starts or ends or shortly before the start or end of the sporting event (e.g., 5 PM). Accordingly, as a result of the second media equipment device receiving a modification to the schedule information (e.g., change in start time from 5 PM to 6 PM) for a media asset performed by another media equipment device in the distribution list, the second media equipment device may adjust the settings to provide the reminder at 6 PM instead of the originally scheduled time of the media asset of 5 PM.

After the user has made the modifications to the schedule information field in screen 1000, the user may select a done editing option. As discussed above in connection with done editing option 806 (FIG. 8), as a result of receiving a user selection of the done editing option in screen 1000, processing circuitry 306 may store the modifications of the schedule information to the media equipment device and generate a modification data structure 1200. As discussed above, the modification data structure 1200 may be transmitted to the central server for approval and promulgation to the media equipment devices in the distribution list. In some implementations, the modification data structure 1200 may be transmitted directly from the media equipment device in the contributors list to all the media equipment devices in the distribution list without first obtaining approval from the central server.

The media equipment devices in the distribution list may receive the schedule information modification and may update the locally stored schedule information for the media asset with the received modifications. In some embodiments, the media equipment devices in the distribution list that receive the modifications may adjust local action settings based on the schedule information modifications. For example, the media equipment devices may adjust the start/end times of scheduled recordings, reminder settings, or any other action setting associated with the media asset that may be dependent upon the schedule information of the media asset.

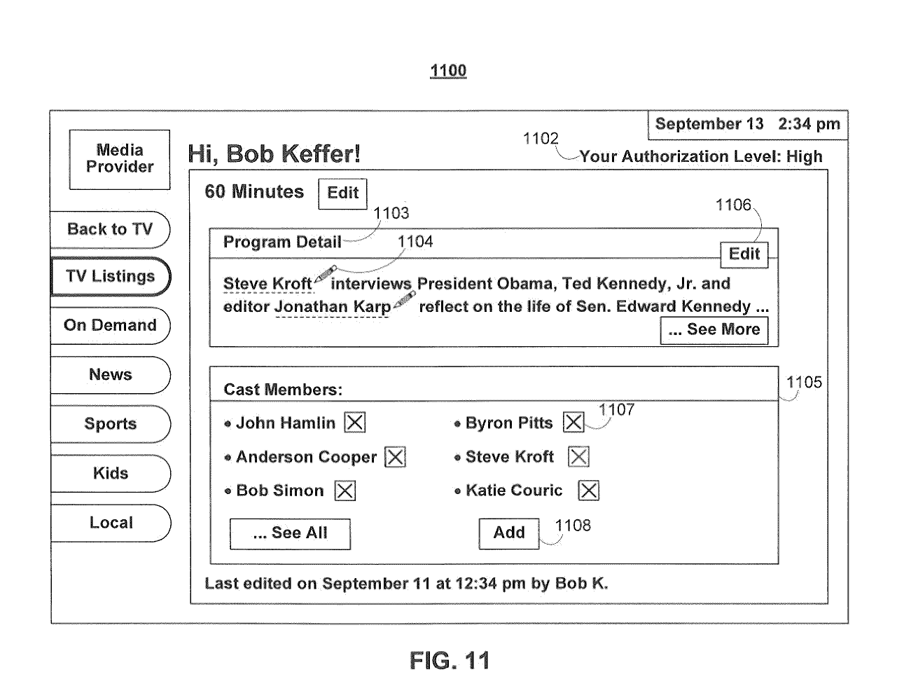

In some embodiments, a user with high authorization level may be allowed to make modifications to any program description information fields. FIG. 11 shows an illustrative display screen 1100 of media asset description information modification for user with a high authorization level 1102 in accordance with an embodiment of the invention. Screen 1100 may include an edit option for each of the fields of the media asset description information fields. In particular, screen 1100 may include an edit option for the title field, media asset detail field 1103 and cast member field 1105. Other fields which the user may modify may include any of the media asset description information fields discussed above such as director fields and schedule information fields.

Selection of any one of the edit options may navigate the user to a screen that allows the user to make modifications to the field of the media asset description information corresponding to the edit option. For example, selection of edit option 1106 may navigate the user to a new screen or may display a window in which the user may make modifications. The modifications may be transmitted to the central server for approval or to all other media equipment devices in the distribution list.

In some embodiments, the user may select edit icon 1104 to make modifications directly in the field displayed in screen 1100. For example, instead of generating a new screen or window in which the user may make modifications to the media asset description field 1104, processing circuitry 306 may provide a text cursor next to the text displayed in screen 1100 allowing the user to make direct modifications as a result of receiving a user selection of edit icon 1104.

In some implementations, some of the items displayed in the fields of the program description information may be modifiable while others are static. In particular, some words of the media asset description field 1104 may be static that they are read-only and not writable or editable. These words may include the actor names, description information that is provided by the media asset producer or other valuable information that nobody but the system operator or media asset provider may change. Edit icons 1104 may indicate which items within a particular media asset description information field are modifiable and/or which are not. For example, edit icon 1104 may indicate that the name of the character in the show 60 Minutes is modifiable but the text or words next to the character name are not. Processing circuitry 306 may receive a user selection of edit icon 1104 and allow the user to insert, remove or replace the modifiable items (e.g., the character name).

Cast member field 1105 of the media asset description information may include a list of people which may appear or perform in the media asset. For example, a movie media asset may include a list of all the actors that appear in the movie and a music media asset may include a list of all the singers or musicians associated with the music asset. Each cast member listed in cast member field 1105 may include a toggle option 1107. Processing circuitry 306 may receive a user selection of toggle option 1107 and as a result may make a modification to the media asset description information cast member field that removes or includes the corresponding character in the media asset description information cast member field. For example, the user may know or become aware that Byron Pitts is no longer scheduled to appear on 60 Minutes (e.g., because of a cancellation). Accordingly, the user may deselect (e.g., select toggle option 1107) to remove Byron Pitts from the list of cast members provided in media asset description information cast member field 1105.

Processing circuitry 306 may generate modification data structure 1200 (FIG. 12) that includes an instruction to remove Byron Pitts (e.g., the selected cast member) from the media asset description information for the selected media asset. The modification may be transmitted to the central server for approval and then distributed to all the media equipment devices in the distribution list. In particular, the central server may transmit the modification of the cast member field 1105 only to the media equipment devices that have selected an opt-in option for cast member field modifications (e.g., users and/or the media equipment devices in the cast member updates distribution list). As discussed above in connection with FIGS. 5 and 6, media equipment devices may opt-in or opt-out of various combinations of modifications made to the media asset description information fields. Media equipment devices that opt-in to receive a particular set of modifications (e.g., modifications made to a particular set of media asset description information fields) may make up one distribution list and media equipment devices that opt-in to receive a different set of modifications (e.g., modifications made to a different set of media asset description information fields) may make up a different distribution list. A media equipment device that opts-in to modifications made to a particular set of media asset description information fields may be configured to automatically accept all modifications made to that set of fields. A media equipment device that opts-out of modifications made to a particular set of media asset description information fields may be configured to never accept any modifications made to that set of fields.

Processing circuitry 306 may receive a user selection of add option 1108. As a result, processing circuitry 306 may allow the user to add one or more cast members which may not be listed in cast member field 1105. For example, the user may know or become aware that a particular person (e.g., Tom Cruise) has recently been scheduled to appear on the selected media asset (e.g., 60 Minutes) (e.g., because of a change in program content). Accordingly, the user may select add option 1108 to add the cast member (e.g., Tom Cruise) to the list of cast members provided in media asset description information cast member field 1105. In some implementations, the user may be provided with a list of cast members from which to select a cast member to add. Alternatively, the user may be provided with a text box that allows the user to manually enter the name or identification of the cast member which the user would like to add to cast member field 1105. The added cast members may be included in the generated modification data structure 1200 for transmission to the central server or other media equipment devices in a distribution list. Similar modification options may be provided for adding, modifying or removing director or producer information as discussed above and below in relation to cast member field 1105 but for the sake of brevity the description of such modification options has been omitted.

Each cast member listed in cast member field 1105 may include an add description field option (not shown). Processing circuitry 306 may receive a user selection of the add description field option and as a result may provide a textbox for the user to enter description information about a particular cast member. Processing circuitry 306 may store the description information in the modification data structure 1200 (FIG. 12) for subsequent transmission to the central server or media equipment devices in a distribution list. In some embodiments, the user may position a cursor over a particular cast member displayed in cast member field 1105 and may select (by pressing a suitable key) the cast member over which the cursor is positioned. As a result of selecting the cast member, processing circuitry 306 may provide in a window or new screen description information about the selected cast member. The user may modify the description information and store the modifications to modification data structure 1200.

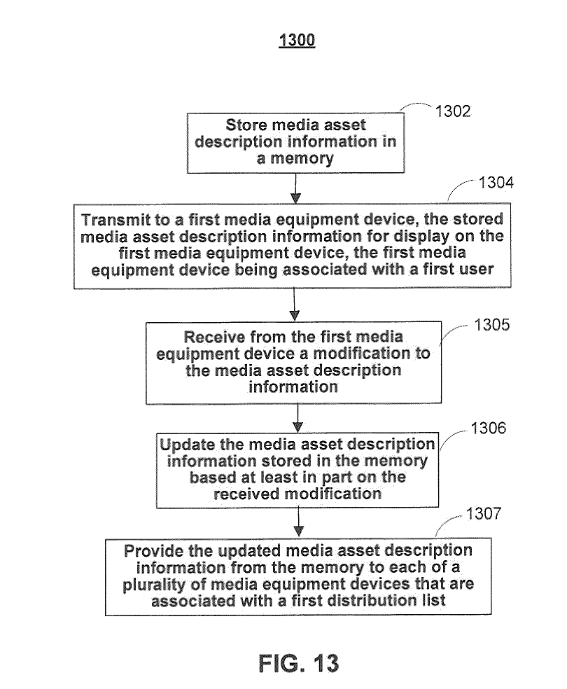

FIG. 13 is an illustrative flow diagram 1300 showing the method for providing a collaborative media guidance application as discussed in relation to FIGS. 5-12. At step 1302, media asset description information is stored in a memory. The memory may reside in the central server which may include media guidance data source 418. For instance, a relational database may be used to maintain and manage the storage of the media asset description information. The relational database, or any suitable data storage mechanism, may be accessible by media equipment devices, such as any one or combination of user television equipment 402, user computer equipment 404, and wireless user communications device 406 (FIG. 4). In certain embodiments, the data may be distributed over a plurality of locations and/or storage devices. The media asset description information may be replicated over multiple storage devices for purposes of redundancy and backup (e.g., using a Redundant Array of Inexpensive Disks (RAID) type storage device). The media asset description information may also be version controlled using applications such as Subversion, TortoiseSVN, or any suitable version control system.

At step 1304, the stored media asset description information is transmitted to a first media equipment device for display on the first media equipment device. For instance, media guidance data source 418 of the central server storing media asset description information may transmit the stored media asset description information to user television equipment 402, user computer equipment 404 or wireless user communications device 406 via communications network 414. The information may be displayed on a user device in an media guidance application environment, a browser, a generic database application, or any suitable application for viewing media asset description information, shown and described above in connection with FIGS. 5-11.

At step 1306, a modification to the media asset description information is received from the first media equipment device. The modification may be received over the Internet, or any suitable communications network. The modification may be received through the return path of the communications link from which the media asset description information was received or through any other alternate path to the central server. The modification may be received via a website using, for example, a form submission. The modification may be received from a database application. For instance, a user may use a media equipment device, such as user television equipment 402, user computer equipment 404 or wireless user communications device 406, to provide the modification. The user input and method of receiving the modification is discussed in relation to FIGS. 7-12. In some embodiments, a user may click on an edit icon or option to begin editing a field of the media asset description information (e.g., a title or summary field of a television program), and provide textual changes to the field. Although the above and below generally describe textual modifications to the media asset description information, the modifications may be any other type (e.g., video addition/deletion, audio addition/deletion, and/or image addition/deletion). A user may then click on a “submit” button to submit the modification to the media asset description information. An example of a modification data structure that may store the modifications a user has made to a media asset description information is shown in FIG. 12.

At step 1306, the media asset description information stored in the memory is updated based at least in part on the received modification. For instance, in response to receiving a modification to a field in the media asset description information (e.g., changing the title of an episode of “60 Minutes” to “60 Minutes: Tribute to the War in Afghanistan”), a command is sent to update the media asset description information stored in the memory of the central server. For instance, a query may be used for a relational database to update a particular entry of the database to update the data in a field in media asset description information for an episode of “MTV Video Music Awards”. In certain embodiments, the update of the media asset description information is conditioned on whether the first user is authorized to modify the particular field (e.g., the user's access/authorization level is checked via authentication and authorization methods). In some implementations, the modification may first be filtered for improper language by the central server before the modification is used to update the media asset description information stored in the memory.

At step 1307, the updated media asset description information is transmitted from the memory of the central server to each of a plurality of media equipment devices that are associated with a first distribution list. In some embodiments, users may opt-in to become part of a distribution list to receive particular updates. The distribution list may be user-specific, for example, ensuring that a user may only receive updates/modification on media asset description information made by certain users (e.g., users with a reliable reputation, official producers of media content, users with certain authorization levels, users belonging to a community, etc.). In some embodiments, the first distribution list may be media asset description information specific, for example, the users of this kind of distribution list may restrict the kinds of media asset description information updates they receive. For instance, a user may elect to only receive modifications made to program summary field of media asset description information and/or elect to not receive modifications made to schedule information field of media asset description information. Details regarding the feature of setting up and joining certain distribution lists is shown in and discussed in relation to FIGS. 5 and 6.

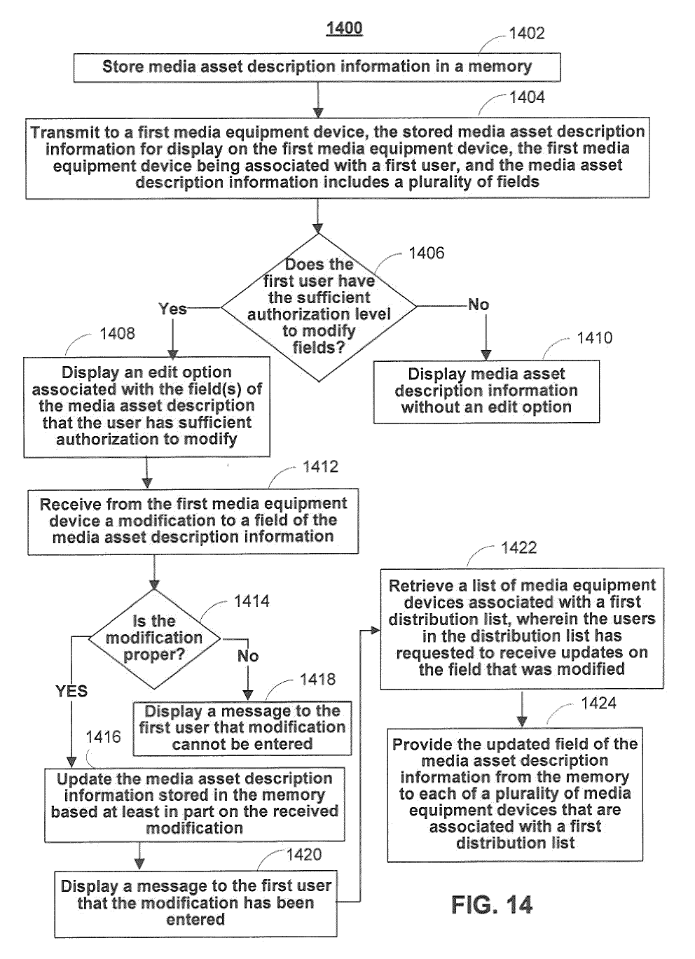

FIG. 14 is an illustrative flow diagram 1400 showing another illustrative method for providing a collaborative media guidance application as discussed in relation to FIGS. 5-12. Step 1402 and step 1404 are discussed in detail in relation to step 1302 and step 1304. In particular, at step 1304, the stored media asset description information is transmitted to the first media equipment device for display on the first media equipment device, where the first media equipment device is associated with a first user. In some embodiments, the media asset description information displayed on the first media equipment device includes a plurality fields, including at least one of, description of content of the media asset, summary of the media asset, title of the media asset, cast member information of the media asset and director information of the media asset.

At step 1406, the authorization level of the user is checked to determine whether the first user has sufficient authorization to modify the fields of the media asset description information. The authorization level may be field-specific, meaning that a user may have authorization to modify a particular set of fields of media asset description information. For instance, a user with low authorization may only be authorized to modify the description of content of the media asset, and may not be authorized to modify the title of the media asset. In some embodiments, a user with low authorization may only be authorized to add or supplement content of various fields and not change or delete text of the fields. There may be a plurality of profiles that defines a set of authorizations for different combinations of fields that a profile is set to have authorization for. For instance, a user may have a “High”, “Medium”, or “Low” authorization levels. A user, such as an data manager, with a “High” authorization may be allowed to edit all fields of the media asset description information.

In some embodiments, the authorization level is based on the kinds of the media asset a user is attempting to modify. Some users may have the authorization to modify all kinds of media assets. Some users may have the authorization to modify only particular kinds of media assets. For example, a user may have the authorization to modify only media assets with content about music. In another example, a user may have the authorization to edit all kinds of media assets except for sports- and news-related media content.

If the user has sufficient authorization to modify at least one field, an edit option associated with the field(s) of the media asset description that the user has sufficient authorization to modify may be provided (step 1408). Otherwise, if the user does not have sufficient authorization to modify the at least one field, then the media asset description information is displayed without an edit option (step 1410). Edit option such as an icon or text showing that the user has the option to edit a particular field is shown in FIGS. 7 and 11. For instance, a user may edit the cast member information when the name of the cast is displayed by clicking on the name of the cast member. A profile of the cast member may be shown and the information about the cast member may be modifiable. A user may modify the list of cast members of a media asset by adding and/or removing cast members. If a user has chose to use the edit option, the user may be provided with the opportunity to provide a modification.

At step 1412, the modification to the field of the media asset description information is received. For example, a modification data structure 1200 showing an exemplary modification is shown in and discussed in relation to FIG. 12.

To prevent malicious or improper modification to the media asset description information, a check is performed to determine whether the modification is proper (step 1414). For instance, profanity and/or offensive language may be filtered to avoid being added into the media asset description information. Modifications that have the evidence showing vandalism of media asset description information, such as intentionally deleting entries or modifying blatantly false information, may be rejected and deemed improper. Minor errors, such as typographical errors, may be filtered and in some cases, automatically corrected. Step 1414 ensures the quality of the modifications to preserve the integrity of the media asset description information. Step 1414 may cause a delay between receiving the modification and the next step. In some embodiments, the authorization level is checked to make sure the user submitting the modification is authorized to make the modification on the media asset description information.

If the modification is proper, the media asset description information stored in the memory is updated based at least in part on the received modification (step 1416). This step is discussed in relation to step 1306. Further, a message may be displayed to the first user that the modification has been entered (step 1420). A prompt such as the one shown in FIG. 9 may be used. Details about prompts are discussed in relation to FIG. 9. If the modification was not proper, a message to the first user that modification cannot be entered may be displayed (step 1418). For instance, the prompt may display a warning for the user that a malicious modification has been entered, and repeated offenses may result in eviction from the community or revocation of membership to the contributors list. In another example, the prompt may display a message that an error has been detected (e.g., misspelling, typos), and may prompt the user to revise and resubmit the modification.

At step 1422, a list of media equipment devices associated with a first distribution list may be retrieved, where the users in the distribution list have requested to receive updates on the field that was modified. For instance, membership information about distribution lists may be maintained in a list server or in a relational database. Details about membership in distribution lists and kinds of distribution lists are discussed in relation to FIGS. 5 and 6.

At step 1424, the updated field of the media asset description information is provided from the memory of the central server to each of the plurality of media equipment devices that are associated with a first distribution list. The updates to the field may be communicated to the media equipment devices in the first distribution list by transmitting a modification data structure 1200 to each of the media equipment devices in the distribution list. In some embodiments, the media equipment devices may transmit the modification data structure 1200 directly to each other in a peer-to-peer configuration. Each media equipment device may receive the modification data structure 1200 may process the modification in accordance with local rules set in the media equipment device. For example, some media equipment devices may have local rules set that reject certain field modifications (or reject modifications made by users with low authorization levels) even though they are part of a contributors list that allows modifications to those fields. The media equipment devices may then display the media asset description information as modified by one or more media equipment devices in the distribution list.

It should be understood, that the above steps of the flow diagrams of FIGS. 13 and 14 may be executed or performed in any order or sequence no limited to the order and sequence shown and described in the figures. Also, some of the above steps of the flow diagrams of FIGS. 13 and 14 may be executed or performed substantially simultaneously where appropriate or in parallel to reduce latency and processing times.

The above described embodiments of the present invention are presented for purposes of illustration and not of limitation, and the present invention is limited only by the claims which follow.

1. A method for providing a collaborative media guidance application, comprising:
storing media asset description information in a memory;
transmitting to a first media equipment device, the stored media asset description information for display on the first media equipment device, the first media equipment device being associated with a first user;
receiving from the first media equipment device a modification to the media asset description information;
updating the media asset description information stored in the memory based at least in part on the received modification; and
providing the updated media asset description information from the memory to each of a plurality of media equipment devices that are associated with a first distribution list.

2. The method in claim 1 further comprising:
providing an opt-in option to a second user of a second media equipment device of the plurality of media equipment devices to become part of the first distribution list; and
receiving user input from the second user requesting for the second user to become part of the first distribution list.

3. The method in claim 2 wherein providing an opt-in option comprises providing an option allowing selection of media asset description update types to be provided to the second user, wherein the media asset description update types comprise at least one of: program metadata update, program description data update, title update, cast member update, director information update and program summary update.

4. The method in claim 1 further comprising:
providing an opt-out option to a second user of a second media equipment device of the plurality of media equipment devices to be excluded from the first distribution list; and
receiving user input from the second user equipment requesting for the second user to be excluded from the first distribution list.

5. The method in claim 4, wherein providing an opt-out option comprises providing an option allowing selection of media asset description update types which to not be provided to the second user, wherein the media asset description update types comprise at least one of: program metadata update, program description data update, title update, cast member update, director information update and program summary update.

6. The method in claim 1, wherein the media asset description information includes at least one of a description of content of the media asset, user reviews, user provided commentary, summary of the media asset, title of the media asset, cast member information of the media asset and director information of the media asset.

7. The method of claim 1 wherein the media asset description information is stored in the memory of a television distribution facility.

8. The method of claim 1 wherein the first distribution list corresponds to a category of media assets.

9. The method of claim 1 wherein receiving the modification from the first media equipment device comprises filtering the modification to prevent an improper change from being included in the update to the media asset description information.

10. The method of claim 1 further comprising:
receiving indication from a second user of a second media equipment device associated with the first distribution list to join a second distribution list;
providing updates to the media asset description information received from any media equipment device associated with the second distribution list to the second media equipment device.

11. The method of claim 1 further comprising:
displaying the media asset description information with the first media equipment device, wherein the media asset description information includes a plurality of fields;
determining a modification authorization level associated with the first user;
displaying an edit option associated with the fields of the media asset description information based on the authorization level of the first user.

12. The method of claim 11, wherein displaying the edit options based on the authorization level comprises:
determining which fields of the media asset description information the first user is authorized to modify; and
wherein the edit option allows the first user to only modify fields which the first user is authorized to modify.

13. A system for providing a collaborative media guidance application, comprising:
a processor configured to:
store media asset description information in a memory;
transmit to a first media equipment device, the stored media asset description information for display on the first media equipment device, the first media equipment device being associated with a first user;
receive from the first media equipment device a modification to the media asset description information;
update the media asset description information stored in the memory based at least in part on the received modification; and
provide the updated media asset description information from the memory to each of a plurality of media equipment devices that are associated with a first distribution list.

14. The system in claim 13, wherein the processor is further configured to:
provide an opt-in option to a second user of a second media equipment device of the plurality of media equipment devices to become part of the first distribution list; and
receive user input from the second user requesting for the second user to become part of the first distribution list.

15. The system in claim 14 wherein the processor is further configured to:
provide an option allowing selection of media asset description update types to be provided to the second user, wherein the media asset description update types comprise at least one of: program metadata update, program description data update, title update, cast member update, director information update and program summary update.

16. The system in claim 13, wherein the processor is further configured to:
provide an opt-out option to a second user of a second media equipment device of the plurality of media equipment devices to be excluded from the first distribution list; and
receive user input from the second user equipment requesting for the second user to be excluded from the first distribution list.

17. The system in claim 16, wherein the processor is further configured to:
provide an option allowing selection of media asset description update types which to not be provided to the second user, wherein the media asset description update types comprise at least one of: program metadata update, program description data update, title update, cast member update, director information update and program summary update.

18. The system in claim 13, wherein the media asset description information includes at least one of a description of content of the media asset, user reviews, user provided commentary, summary of the media asset, title of the media asset, cast member information of the media asset and director information of the media asset.

19. The system of claim 13, wherein the media asset description information is stored in the memory of a television distribution facility.

20. The system of claim 13, wherein the first distribution list corresponds to a category of media assets.

21. The system of claim 13, wherein the processor is further configured to filter the modification to prevent an improper change from being included in the update to the media asset description information.

22. The system of claim 13, wherein the processor is further configured to:
receive indication from a second user of a second media equipment device associated with the first distribution list to join a second distribution list;
provide updates to the media asset description information received from any media equipment device associated with the second distribution list to the second media equipment device.

23. The system of claim 13, wherein the processor is further configured to:
display the media asset description information with the first media equipment device, wherein the media asset description information includes a plurality of fields;
determine a modification authorization level associated with the first user;
display an edit option associated with the fields of the media asset description information based on the authorization level of the first user.

24. The system of claim 23, wherein the processor is further configured to:
determine which fields of the media asset description information the first user is authorized to modify; and
wherein the edit option allows the first user to only modify fields which the first user is authorized to modify.

25-36. (canceled)
